(19) United States
(12) Patent Application Publication
(10) Pub. No.: US 2026/0127922 A1
(43) Pub. Date: May 7, 2026

(54) SYSTEMS AND METHODS FOR VISUAL BASED COMMUNICATION AND PLANT MARSHALING

(71) Applicant: Ford Global Technologies, LLC, Dearborn, MI (US)

(72) Inventors: Stuart C. Salter, White Lake, MI (US); Krishna Bandi, Novi, MI (US); Mario Anthony Santillo, Canton, MI (US); Brendan Diamond, Naples, FL (US)

(73) Assignee: Ford Global Technologies, LLC, Dearborn, MI (US)

(21) Appl. No.: 18/898,140

(22) Filed: Sep. 26, 2024

(51) Int. Cl. G07C 5/08; B60S 5/00; B62D 65/18

(52) U.S. Cl. CPC G07C 5/0825; B62D 65/18; B60S 5/00

(57) ABSTRACT

A method includes the determination of a current status associated with a vehicle and the output of an indication corresponding to the current status associated with the vehicle via a lighting element of the vehicle. The method also includes the receipt of one or more marshaling commands based on the indication and the initiation of one or more actions in response to the receipt of the one or more marshaling commands.

### FIELD

The present disclosure relates to marshaling a vehicle. More specifically, the present disclosure relates to marshaling the vehicle using visual based communication.

### BACKGROUND

The statements in this section merely provide background information related to the present disclosure and may not constitute prior art.

The utilization of vehicle exterior lighting is increasingly used for more than just illuminating a pathway for the vehicle. For example, vehicle exterior lighting can be used for visual based communication to onboard and/or offboard the vehicle from a server in a marshaling setting. However, there can be inaccuracies of identification of a particular vehicle in a fleet of vehicles when the vehicle exterior lighting is used to communicate a message, and/or limitations with respect to message(s) that may be communicated by the vehicle exterior lighting. The present disclosure addresses these and other issues related to visual based communication associated with vehicle exterior lighting of a vehicle.

### SUMMARY

This section provides a general summary of the disclosure and is not a comprehensive disclosure of its full scope or all of its features.

The present disclosure provides a method comprising: determining a current status associated with a vehicle; outputting, via a lighting element of the vehicle, a first indication corresponding to the current status associated with the vehicle; receiving one or more marshaling commands based on the first indication; and initiating one or more actions in response to the receipt of the one or more marshaling commands; wherein the vehicle is a partially built vehicle configured to be marshaled through a manufacturing environment, and wherein the lighting element is permanently integrated within a body of the vehicle or temporarily affixed to the body of the vehicle; wherein the manufacturing environment includes one or more workstations equipped with an electronic device, and wherein the electronic device is configured to output a second indication, and further wherein the second indication is a visual cue that corresponds to a step of a manufacturing process, a destination of the vehicle, a corresponding location associated with the vehicle, a delay in the manufacturing process associated with the vehicle, a delay in a marshaling process associated with the vehicle, a duration of the vehicle being stopped, or a combination thereof; wherein the first indication and the second indication comprise a light color output, a sequence of light output, or a combination thereof; wherein the first indication is outputted by different parts of the lighting element corresponding to different vehicle systems, and wherein the first indication is a visual cue that corresponds to a location associated with a construct of the vehicle that needs repair, a location associated with the construct of the vehicle that needs inspection, a fault associated with the vehicle, a trajectory associated with a current movement of the vehicle, a predicted future location associated with the vehicle, one or more vehicle options, or a combination thereof; wherein a frequency and a duration of the output of the first indication varies based on global positioning system coordinates of the vehicle and one or more characteristics associated with the vehicle, wherein the one or more characteristics include a state of charge of a battery, a step of a manufacturing process, a key fob, a phone as a key feature, Bluetooth® low energy-based wireless communication, cellular-based wireless communication, wireless fidelity-based wireless communication, or a combination thereof; and wherein the one or more actions include marshaling of the vehicle to a repair bay, a parking location, or a future location.

The present disclosure provides a system comprising: a vehicle system configured to: determine a current status associated with a vehicle, output, via a lighting element of the vehicle, a first indication corresponding to the current status associated with the vehicle, receive one or more marshaling commands based on the first indication, and initiate one or more actions in response to the receipt of the one or more marshaling commands; and the infrastructure system configured to: observe the first indication, and transmit the one or more marshaling commands based on the observation of the first indication; wherein the vehicle is a partially built vehicle configured to be marshaled through a manufacturing environment, and wherein the lighting element is permanently integrated within a body of the vehicle or temporarily affixed to the body of the vehicle; wherein the manufacturing environment includes one or more workstations equipped with an electronic device, and wherein the electronic device is configured to output a second indication, and further wherein the second indication is a visual cue that corresponds to a step of a manufacturing process, a destination of the vehicle, a corresponding location associated with the vehicle, a delay in the manufacturing process associated with the vehicle, a delay in a marshaling process associated with the vehicle, a duration of the vehicle being stopped, or a combination thereof; wherein the first indication and the second indication comprise a light color output, a sequence of light output, or a combination thereof; wherein the first indication is outputted by different parts of the lighting element corresponding to different vehicle systems, and wherein the first indication is a visual cue that corresponds to a location associated with a construct of the vehicle that needs repair, a location associated with the construct of the vehicle that needs inspection, a fault associated with the vehicle, a trajectory associated with a current movement of the vehicle, a predicted future location associated with the vehicle, one or more vehicle options, or a combination thereof; wherein a frequency and a duration of the output of the first indication varies based on global positioning system coordinates of the vehicle and one or more characteristics associated with the vehicle, wherein the one or more characteristics include a state of charge of a battery, a step of a manufacturing process, a key fob, a phone as a key feature, Bluetooth® low energy-based wireless communication, cellular-based wireless communication, wireless fidelity-based wireless communication, or a combination thereof; and wherein the one or more actions include marshaling of the vehicle to a repair bay, a parking location, or a future location.

The present disclosure provides one or more non-transitory computer-readable media storing processor-executable instructions that, when executed by at least one processor, cause the at least one processor to: determine a current status associated with a vehicle; output, via a lighting element of the vehicle, a first indication corresponding to the current status associated with the vehicle; receive one or more marshaling commands based on the first indication; and initiate one or more actions in response to the receipt of the one or more marshaling commands, wherein the one or more actions include marshaling of the vehicle to a repair bay, a parking location, or a future location; wherein the vehicle is a partially built vehicle configured to be marshaled through a manufacturing environment, and wherein the lighting element is permanently integrated within a body of the vehicle or temporarily affixed to the body of the vehicle; wherein the manufacturing environment includes one or more workstations equipped with an electronic device, and wherein the electronic device is configured to output a second indication, and further wherein the second indication is a visual cue that corresponds to a step of a manufacturing process, a destination of the vehicle, a corresponding location associated with the vehicle, a delay in the manufacturing process associated with the vehicle, a delay in a marshaling process associated with the vehicle, a duration of the vehicle being stopped, or a combination thereof; wherein the first indication and the second indication comprise a light color output, a sequence of light output, or a combination thereof; wherein the first indication is outputted by different parts of the lighting element corresponding to different vehicle systems, and wherein the first indication is a visual cue that corresponds to a location associated with a construct of the vehicle that needs repair, a location associated with the construct of the vehicle that needs inspection, a fault associated with the vehicle, a trajectory associated with a current movement of the vehicle, a predicted future location associated with the vehicle, one or more vehicle options, or a combination thereof; and wherein a frequency and a duration of the output of the first indication varies based on global positioning system coordinates of the vehicle and one or more characteristics associated with the vehicle, wherein the one or more characteristics include a state of charge of a battery, a step of a manufacturing process, a key fob, a phone as a key feature, Bluetooth® low energy-based wireless communication, cellular-based wireless communication, wireless fidelity-based wireless communication, or a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates a display depicting a marshaling environment in accordance with one or more embodiments of the present disclosure;

FIGS. 3A-3D illustrate different lighting displays emitted from a lighting element of a vehicle in accordance with one or more embodiments of the present disclosure;

FIG. 4 is a flowchart illustrating an example method for marshaling a vehicle and/or visual based communication with the vehicle using vehicle lighting in accordance with one or more embodiments of the present disclosure; and

FIG. 5 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide a means for marshaling a vehicle and/or visual based communication with the vehicle. In one or more embodiments, as the vehicle progresses through a manufacturing process, the vehicle can output one or more visual cue(s) indicative of a status of the vehicle. However, it is understood that the vehicle can output the one or more visual cue(s) at any time and outside of the manufacturing process as well. It is also understood that the one or more visual cue(s) can indicate a location associated with a construct (e.g., a component internally and/or externally disposed related to the vehicle) of the vehicle that needs repair, a location associated with the construct of the vehicle that needs inspection, a fault associated with the vehicle, a trajectory associated with a current movement of the vehicle, a predicted future location associated with the vehicle, one or more vehicle options, or a combination thereof, among others.

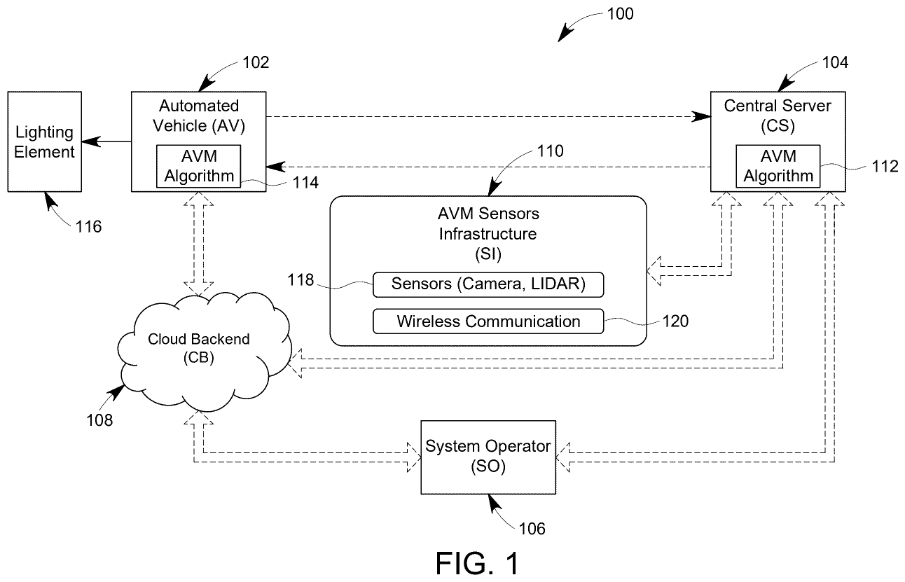

Referring now to FIG. 1 there is shown a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a central server 104, a system operator 106, a cloud system 108, and an infrastructure system 110. The central server 104 operates as a central point of communication related to the AVM system 100 and manages and/or facilitates any manufacturing process associated with the vehicle 102. For example, the central server 104 facilitates marshaling of the one or more vehicles, which causes the one or more vehicles to travel through (e.g., traverse) a marshaling environment (e.g., a factory floor or parking lot).

The central server 104 is configured to wirelessly communicate directly with each of the components of the AVM system 100 (e.g., the vehicle 102, the system operator 106, the cloud system 108, and the infrastructure system 110) and can include an infrastructure-side AVM algorithm 112. The central server 104 is also configured to provide logical interface information received from the infrastructure system 110 to the vehicle 102. Additionally, the central server 104 is configured to calculate one or more maneuvers (e.g., movements) associated with the vehicle 102.

The infrastructure-side AVM algorithm 112 processes status information associated with at least the vehicle 102 of the one or more vehicles. It is understood that the infrastructure-side AVM algorithm 112 processes status information associated with each vehicle of the one or more vehicles. The central server 104 is configured to utilize the infrastructure-side AVM algorithm 112 to transmit one or more instructions and/or process information received from each of the components of the AVM system 100 (e.g., the vehicle 102, the system operator 106, the cloud system 108, and the infrastructure system 110). For example, the received information can be related to, but is not limited to, marshaling the vehicle 102 and/or visual based communication with the vehicle 102.

Particularly, based on the direct communication with the one or more vehicles, the central server 104 is further configured to cause the one or more vehicles to start, stop, or pause progression through the marshaling environment. The central server 104 is further configured to control a marshaling speed of the one or more vehicles as the one or more vehicles travel through the marshaling environment.

The vehicle 102 marshaled through the marshaling environment can be a partially built vehicle such as a vehicle top-hat or a vehicle base. However, it is understood that the vehicle 102 can be fully assembled as well. The vehicle 102 includes a vehicle-side AVM algorithm 114 and a lighting element 116. In one or more embodiments, the vehicle 102 utilizes the vehicle-side AVM algorithm 114 to process and send information gathered by one or more components associated with the construct of the vehicle 102, such as a component internally and/or externally disposed related to the vehicle 102. For example, although not shown, the components associated with the construct of the vehicle 102 can include a wireless transmission module, a vehicle central gateway module, a vehicle infotainment system, one or more vehicle sensors, a vehicle battery, a vehicle global navigation satellite (e.g., GNSS), a vehicle navigation mapping system, and/or a controller area network (CAN) vehicle bus. It is understood that by utilizing any of the one or more components associated with the construct of the vehicle 102, the vehicle 102 is equipped with a system for automated vehicle marshaling operation.

In one or more embodiments, the vehicle-side AVM algorithm 114 is configured to determine the status information associated with the vehicle 102. In another one or more embodiments, the vehicle-side AVM algorithm 114 is also configured to cause the lighting element 116 to output an indication corresponding to the status information associated with the vehicle 102. In one or more embodiments, in addition to or in alternative to the vehicle-side AVM algorithm 114, the infrastructure-side AVM algorithm 112 may determine the status information associated with the vehicle 102 based on the processed status information. Additionally, the infrastructure-side AVM algorithm 112 may also be configured to cause the lighting element 116 to output the indication corresponding to the status information associated with the vehicle 102 based on a transmission of one or more instructions from the infrastructure system 110 to the vehicle 102.

The lighting element 116 can include an array of lights that are affixed to the vehicle 102. It is understood, however, that the lighting element 116 can be a singular light as well. In one or more embodiments, the lighting element 116 can be permanently integrated within a body of the vehicle 102. In another one or more embodiments, the lighting element 116 can be temporarily affixed to the body of the vehicle 102. As an example, the lighting element 116 can be an accent strip of red, green, blue (e.g., RGB) light-emitting diode(s) (e.g., LED) configured to turn ON and OFF in a pattern to provide one or more visual cue(s). As another example, the one or more visual cue(s) can correspond to a particular status of the vehicle 102 and/or indicate a particular location associated with the construct of the vehicle 102 that needs repair, a location associated with the construct of the vehicle 102 that needs inspection, a fault associated with the vehicle 102, a trajectory associated with a current movement of the vehicle 102, a predicted future location associated with the vehicle 102, one or more vehicle options, or a combination thereof, among others. However, it is understood that the one or more visual cue(s) can correspond to any status of the vehicle 102 and/or any other related information associated with the vehicle 102. It is also understood that the lighting element 116 can be any other type of lighting, and is not limited to LED lighting.

The one or more visual cue(s) can comprise a light color output, a sequence of light output, or a combination thereof. However, it is understood that the visual cue(s) can comprise any other light-based means of communication. For example, the one or more visual cue(s) can be outputted by different parts of the lighting element 116, enabling a display of different colors associated with different vehicle systems. As another example, the pattern(s) can differ based on the particular status of the vehicle 102 and may change an illumination sequence of the lighting element 116, change a brightness of the lighting element 116, and/or make any change to the lighting element 116 related to the indication of the particular status of the vehicle 102. As yet another example, the pattern(s) can also indicate one or more options and/or whether certain equipment should be loaded onto the vehicle 102 (e.g., or each vehicle of a fleet of vehicles).

In one or more embodiments a frequency and/or a duration of the output of the one or more visual cue(s) can vary based on global positioning system coordinates of the vehicle and/or one or more characteristics associated with the vehicle, wherein the one or more characteristics include a state of charge of a battery, a step of a manufacturing process, a key fob, a phone as a key feature, Bluetooth® low energy-based wireless communication, cellular-based wireless communication, wireless fidelity-based wireless communication, or a combination thereof, among others. However, it is understood that the one or more characteristics can include any other communication-based features related to the vehicle 102. For example, the frequency and/or the duration of the output of the one or more visual cue(s) can be varied to save power associated with the vehicle 102 and/or the lighting element 116.

The central server 104 is configured to cause the infrastructure system 110 to monitor the progression of the one or more vehicles as the vehicle(s) move through the marshaling environment. In one or more embodiments, the one or more vehicles are marshaled through the marshaling environment as part of a zero faults forward process. For example, by implementing the zero faults forward process, diagnostic tools that are typically plugged in and/or wirelessly connected electronic devices to the one or more vehicles can be replaced. For example, the electronic devices can include, but are not limited to a cellular-phone, a smartphone, a tablet, or a laptop. The central server 104 is also configured to cause the infrastructure system 110 to capture the visual cue(s) outputted from the lighting element 116 of the vehicle(s) 102. The infrastructure system 110 includes a sensor component 118 and a wireless communication component 120. For example, the wireless communication component 120 may utilize GPS, Wi-Fi, satellite, 3G/4G/5G, and/or Bluetooth^{TM} to communicate with the one or more vehicles. It is understood that by utilizing any of the sensor component 118 and/or the wireless communication component 120, the infrastructure system 110 is configured to perform localization function(s) associated with the marshaling of the vehicle 102, such as, but not limited to, perception, path-planning, detection, controls, response of the vehicle 102, or a combination thereof, among others.

The wireless communication component 120 communicates with the sensor component 118 that is configured to manage, for example, one or more of cameras, lidar, radar, and/or ultrasonic devices. The sensor component 118 monitors the movement of the one or more vehicles as the one or more vehicles are marshaled through the marshaling environment. Additionally, the sensor component 118 obtains the visual cue(s) outputted from the lighting element 116 of the vehicle(s) 102. It is understood that the infrastructure system 110 can forward (e.g., transmit) the obtained (e.g., captured) visual cue(s) to the central server 104. It is also understood that the central server 104 is configured to process the received one or more visual cue(s) and determine what indication the visual cue(s) corresponds to, in relation to a status of the vehicle(s) 102.

The system operator 106 can be a human operator tasked with monitoring the marshaled one or more vehicles by communicating with the cloud system 108. In one or more embodiments, the system operator 106 communicates with the cloud system 108 and/or monitors the one or more vehicles via a user device (not shown) and/or a human eye of the human operator. However, it is understood that the system operator 106 can also be a non-human operator, such as a mainframe controller, a machine-learning based control system, or any neural network. It is also understood that the system operator 106 is tasked with managing and/or supervising operation of the vehicle 102 (e.g., via an in-facility interface) during automated marshaling, an onboarding process, and/or at individual locations. The system operator 106 is able to receive instructions from the central server 104 and forward those instructions on to the one or more vehicles, via the cloud system 108. For example, the instructions received from the central server 104 can be one or more marshaling commands that can cause the one or more vehicles to travel to a vehicle repair bay, a parking location, a future location, or any other location. As another example, the instructions can be based on the processed one or more visual cue(s).

Besides visual monitoring of the one or more visual cue(s), the system operator 106 can obtain other information related to the correspondent indication(s) related to the one or more visual cue(s) from the cloud system 108. It is understood that the cloud system 108 is a backend system that may represent an original equipment manufacturer cloud system responsible for remote engagement and/or disengagement of AVM application(s) including enrollment and/or unenrollment of the vehicle 102 from the AVM system 100.

As an example, the obtained other information can be displayed on the user device. For example, the one or more vehicles can report any of the indications to the cloud system 108. As another example, in response to receiving the reported indication(s), the cloud system 108 can determine a repair schedule to address the indication(s) that may correspond to a reparable issue related to the one or more vehicles. As yet another example, in response to receiving the reported indication(s), the cloud system 108 can also report the indication(s) to the central server 104, via the system operator 106, so that the central server 104 may marshal the one or more vehicles to a repair facility or any other location. As a further example, in response to receiving the reported indication(s), the cloud system 108 can also cause for the one or more vehicles to emit a particular light pattern indicative of the future location of the vehicle (e.g., via the infrastructure system 110 and/or the system operator 106). For example, a particular color may correspond to a particular parking location or a particular repair bay. It is understood that the cloud system 108 may utilize various software applications to determine the repair schedule, report the indication(s), and/or cause the emission of the light pattern. As another example, the particular color may also indicate how long one or more vehicles have been stopped for or how long the one or more vehicles have gone unused.

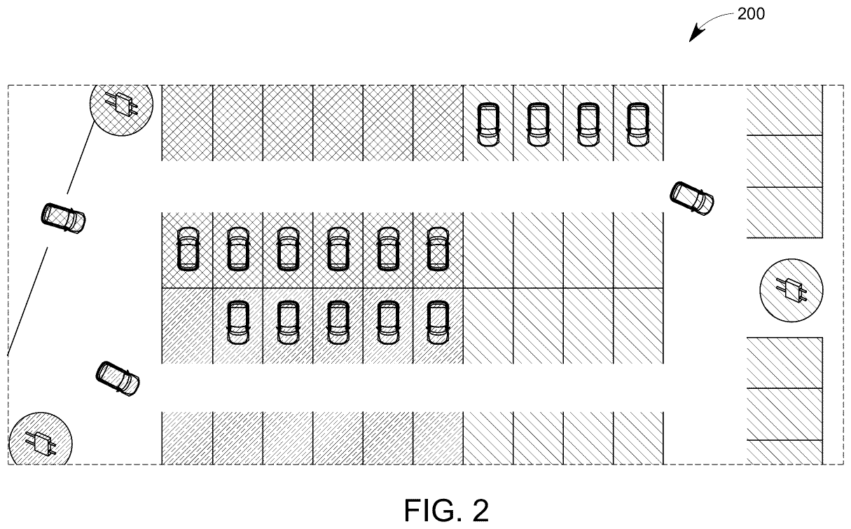

While the user device can be a tablet used by the system operator 106, a tablet (or any other suitable electronic device) can also be used at one or more workstations dispersed throughout the marshaling environment. As an example, and as is shown in FIG. 2, the user device can depict, on a display 200, a virtual rendition (e.g., a digital twin) of the manufacturing facility that is color coded so that the status information associated with the vehicle 102 can be easily noticed and/or to highlight a particular vehicle amongst many vehicles. In one or more embodiments, and in a case wherein the lighting element 116 is not affixed to the vehicle 102, the user device can display a virtual lighting system that is viewable by the system operator 106 via an augmented reality system that can correspond to the virtual rendition of the manufacturing facility.

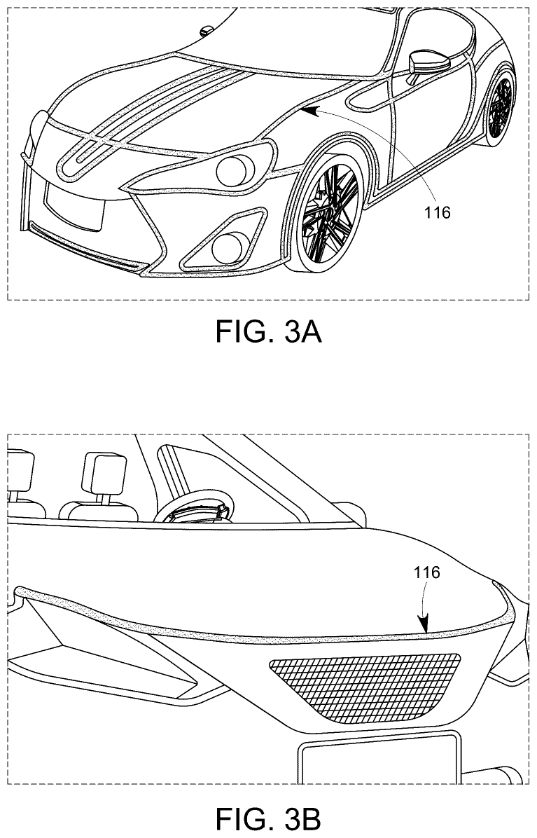

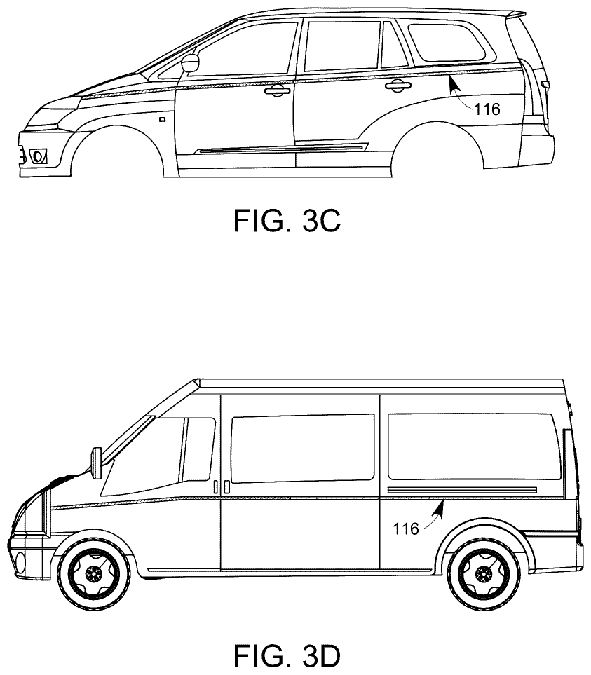

FIGS. 3A-3D illustrate examples of different embodiments of utilization of the lighting element 116 to communicate the status information associated with the vehicle 102 to at least the infrastructure system 110 and/or the system operator 106. It is understood that the vehicle 102 does not need to be marshaled and/or participating in a marshaling setting (e.g., or process) for the lighting element 116 to output the one or more visual cue(s) indicating a status of the vehicle 102 and/or a location associated with a construct of the vehicle 102 that needs repair, a location associated with the construct of the vehicle 102 that needs inspection, a fault associated with the vehicle 102, a trajectory associated with a current movement of the vehicle 102, a predicted future location associated with the vehicle 102, one or more or more vehicle options, or a combination thereof, among others. For example, and in other words, a repair facility may be able to determine any of the correspondent indication(s) related to the one or more visual cue(s) based on the output of the lighting element 116 of a manually operated vehicle. It is understood that the one or more visual cue(s) can correspond to any status of the vehicle 102 and/or any other related information associated with the vehicle 102.

For example, FIG. 3A illustrates activation of an entirety of the vehicle's 102 lighting element 116 extending along an entirety of the body of the vehicle 102. It is understood that full activation of the entirety of the vehicle's 102 lighting element 116 can indicate a start of the vehicle 102. It is also understood that full activation of the entirety of the lighting element 116 of the vehicle 102 at the start of the vehicle 102 can indicate full operation of the lighting element 116. However, it is understood that full activation of the entirety of the lighting element 116 of the vehicle 102 can represent any other indication of functionality associated with the lighting element 116 and/or the vehicle 102.

As another example, FIG. 3B illustrates activation of the lighting element 116 correspondent to an area relative to a front bumper of the vehicle 102. It is understood that activation of the lighting element 116 correspondent to the area relative to the front bumper of the vehicle 102 can indicate status information of the vehicle 102 and/or a needed repair to the front bumper of the vehicle 102, a needed inspection of the front bumper of the vehicle 102, a trajectory associated with a current movement of the vehicle 102, a predicted future location associated with the vehicle 102, one or more vehicle options, or a combination thereof, among others. However, it is understood that the activation of the lighting element 116 correspondent to the area relative to the front bumper of the vehicle 102 can correspond to any status of the vehicle 102 and/or any other related information associated with the vehicle 102.

As another example, FIG. 3C illustrates activation of different portions of the lighting element 116 installed on a side of a partially assembled version of the vehicle 102 (e.g., a top-hat version of the vehicle 102). As yet another example, FIG. 3D illustrates activation of different portions of the lighting element 116 installed on a side of a fully assembled version of the vehicle 102. It is understood that while FIGS. 3C and 3D depict the lighting element 116 as installed on a side of the vehicle 102, the lighting element 116 can be installed (e.g., affixed) anywhere on the vehicle 102, including another side, front, back, or top of the vehicle 102. It is also understood that the activation of different portions of the lighting element 116 can be indicative of status information associated with the vehicle 102 or any other information associated with the vehicle 102. It is further understood that different lighting elements affixed to the vehicle 102 can each output a different pattern or visual cue(s) and it is not required that each lighting element output the same pattern or visual cue(s).

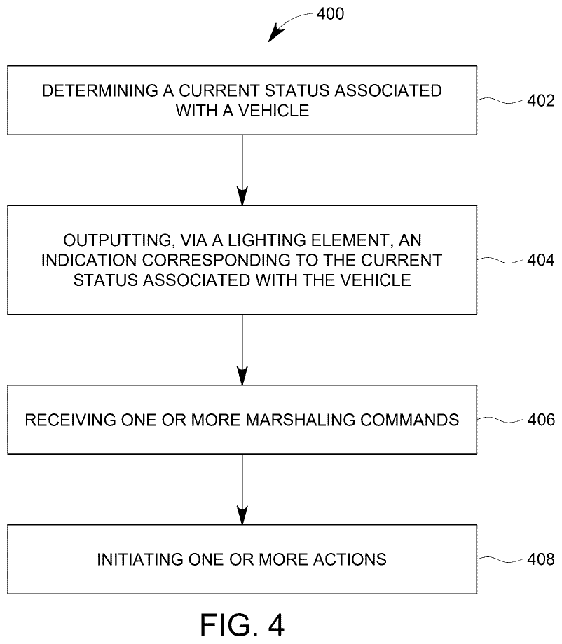

FIG. 4 is a flowchart illustrating an example method 400 for marshaling a vehicle (e.g., the vehicle 102) and/or visual based communication with the vehicle. At operation 402, a current status associated with the vehicle is determined. For example, the current status associated with the vehicle is determined by a vehicle-side algorithm (e.g., the vehicle-side AVM algorithm 114). As another example, the vehicle is partially built vehicle configured to be marshaled through a manufacturing environment. As yet another example, the manufacturing environment includes one or more workstations equipped with an electronic device.

At operation 404, a first indication corresponding to the current status associated with the vehicle is outputted. For example, the first indication is outputted via a lighting element (e.g., the lighting element 116) of the vehicle. As another example, the first indication is outputted via the lighting element of the vehicle to an infrastructure system (e.g., the infrastructure system 110) or one or more human operators (e.g., the system operator 106). It is understood that the first indication can be outputted via the lighting element of the vehicle to another vehicle or any other recipient or system that can perceive (e.g., process and/or capture) the first indication. In one or more embodiments, the lighting element is permanently integrated within a body of the vehicle. In another one or more embodiments, the lighting element is temporarily affixed to the body of the vehicle. In yet another example, the first indication is outputted by different parts of the lighting element corresponding to different vehicle systems. In a further example, the first indication is a visual cue that corresponds to a location associated with a construct (e.g., a component internally and/or externally disposed related to the vehicle) of the vehicle that needs repair, a location associated with the construct of the vehicle that needs inspection, a fault associated with the vehicle, a trajectory associated with a current movement of the vehicle, a predicted future location associated with the vehicle, one or more vehicle options, or a combination thereof, among others. As another example, the first indication is also a visual cue that is used to assign a specific operator of the one or more human operators to investigate an issue associated with the vehicle.

For example, a frequency and a duration of the first indication varies based on global positioning system coordinates of the vehicle and one or more characteristics associated with the vehicle, wherein the one or more characteristics include a state of charge of a battery, a step of a manufacturing process, a key fob, a phone as a key feature, Bluetooth® low energy-based wireless communication, cellular-based wireless communication, wireless fidelity-based wireless communication, or a combination thereof, among others. As another example, the electronic device is configured to output a second indication. As yet another example, the second indication is a visual cue that corresponds to a step of a manufacturing process, a destination of the vehicle, a corresponding location associated with the vehicle, a delay in the manufacturing process associated with the vehicle, a delay in a marshaling process associated with the vehicle, a duration of the vehicle being stopped, or a combination thereof, among others. As a further example, the first indication and the second indication comprise a light color output, a sequence of light output, or a combination thereof.

At operation 406, one or more marshaling commands is received. In one or more embodiments, the one or more marshaling commands is received from the infrastructure system. In another one or more embodiments, the one or more marshaling commands is received from a user input of the one or more human operators. It is understood, however, that the one or more marshaling commands is received from the infrastructure system and the user input. As yet another example, the one or more marshaling commands is received based on the first indication. At operation 408, one or more actions is initiated in response to the receipt of the one or more marshaling commands. For example, wherein the one or more actions include marshaling of the vehicle to a repair bay, a parking location, or a future location.

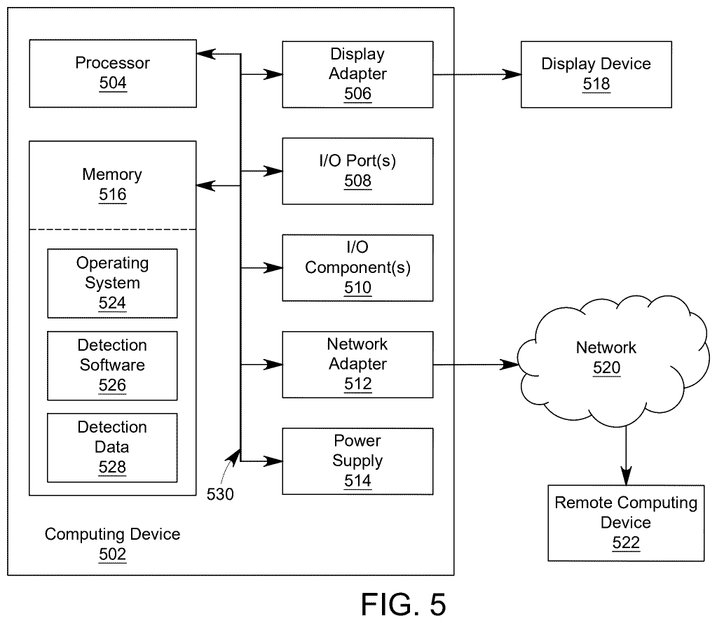

FIG. 5 illustrates an operating environment that facilitates the performance of the one or more systems and methods described herein. More specifically, the systems and methods described herein can be implemented using a computing device 502. For example, the computing device 502 can be a personal computer, a desktop, a laptop, a tablet, a hand-held computer, a server, a workstation, a mainframe, a wearable computer, a supercomputer, or a combination thereof. However, it is understood that the aforementioned examples of the computing device 502 is non-exhaustive and the computing device 502 can be any type of processing or computing device. The computing device 502 generally includes a processor 504, a display adapter 506, one or more input/output port(s) 508, one or more input/output component(s) 510, a network adapter 512, a power supply 514, and a memory 516. However, it is understood that the computing device 502 can include any additional components therein and is not required to include any of the listed components (e.g., the processor 504, the display adapter 506, the one or more input/output port(s) 508, the one or more input/output component(s) 510, the network adapter 512, the power supply 514, and the memory 516).

The processor 504 is configured to provide instructions to the computing device 502 so that the computing device 502 can process one or more tasks including the implementation of a software program to perform one or more operations as described in more detail herein. It is also understood that the computing device 502 may include any number or processors 504 therein. The display adapter 506 can be a graphics card or a video board that provides the computing device 502 with a capability to display content on a display device 518. For example, the display device 518 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 518 is non-exhaustive and that the display device 518 can be any type of device capable of providing a visual display.

The input/output port(s) 508 provide a number of interfaces (e.g., sockets) for one or more cables to connect to the computing device 502. It is understood that there may be any number of input/output port(s) 508 on the computing device 502. For example, the input/output port(s) 508 provides a means for the computing device 502 to receive signals and/or data from an external device connected to the computing device 502 via the one or more cables. As another example, the input/output port(s) 508 provide a means for the computing device 502 to send signals and/or data to an external device connected to the computing device 502 via the one or more cables. The input/output component(s) 510 can include one or more components that support the input/output port(s) 508 such as, but not limited to, a switch, a push button, a pressure mat, a float switch, a keypad, a radio receive, or a combination thereof.

The network adapter 512 can be any type of network interface controller that is configured to provide a means for communicating over a network 520 with another computing device, such as a remote computing device 522. For example, the remote computing device 522 can be a user device such as a cellular-phone, a smartphone, a tablet, a laptop, or a combination thereof. The power supply 514 is configured to convert alternating high voltage current (e.g., AC) into direct current (e.g., DC) to provide power to the other components (e.g., the processor 504, the display adapter 506, the one or more input/output port(s) 508, the one or more input/output component(s) 510, the network adapter 512, and the memory 516) of the computing device 502.

Additionally, the memory 516 can be a mass storage device and/or a system memory such as a hard disk drive, a memory card, a solid-state drive, random access memory (RAM), or a combination thereof. The memory 516 is configured to provide storage for instructions and data associated with the operation of the computing device 502. The memory 516 can generally include an operating system 524, detection software 526, and detection data 528. For example, the operating system 524 is configured to manage and/or process any of the data and/or instructions associated with the detection software 526 and/or detection data 528, as described in more detail herein.

Furthermore, a system bus 530 is also included within the computing device 502 that is configured to couple each of the various components (e.g., the processor 504, the display adapter 506, the one or more input/output port(s) 508, the one or more input/output component(s) 510, the network adapter 512, the power supply 514, and the memory 516) of the computing device 502. It is also understood that each of the components of the computing device 502, and the functionality associated with each of the components of the computing device 502, may be implemented within the remote computing device 522. While the operating environment illustrated within FIG. 5 depicts a particular configuration associated with at least the computing device 502, the network 520, and the remote computing device 522, it is understood that the operating environment may be configured in any way.

Thus, one or more examples of the present disclosure provide a means for visual based communication in at least a marshaling setting, wherein a vehicle is able to diagnose itself and communicate status information (e.g., or any other information) via an output of varying lighting patterns displayed on a lighting element of the vehicle.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
determining a current status associated with a vehicle;
outputting, via a lighting element of the vehicle, a first indication corresponding to the current status associated with the vehicle;
receiving one or more marshaling commands based on the first indication; and
initiating one or more actions in response to the receipt of the one or more marshaling commands.

2. The method of claim 1, wherein the vehicle is a partially built vehicle configured to be marshaled through a manufacturing environment, and wherein the lighting element is permanently integrated within a body of the vehicle or temporarily affixed to the body of the vehicle.

3. The method of claim 2, wherein the manufacturing environment includes one or more workstations equipped with an electronic device, and wherein the electronic device is configured to output a second indication, and further wherein the second indication is a visual cue that corresponds to a step of a manufacturing process, a destination of the vehicle, a corresponding location associated with the vehicle, a delay in the manufacturing process associated with the vehicle, a delay in a marshaling process associated with the vehicle, a duration of the vehicle being stopped, or a combination thereof.

4. The method of claim 3, wherein the first indication and the second indication comprise a light color output, a sequence of light output, or a combination thereof.

5. The method of claim 1, wherein the first indication is outputted by different parts of the lighting element corresponding to different vehicle systems, and wherein the first indication is a visual cue that corresponds to a location associated with a construct of the vehicle that needs repair, a location associated with the construct of the vehicle that needs inspection, a fault associated with the vehicle, a trajectory associated with a current movement of the vehicle, a predicted future location associated with the vehicle, one or more vehicle options, or a combination thereof.

6. The method of claim 1, wherein a frequency and a duration of the output of the first indication varies based on global positioning system coordinates of the vehicle and one or more characteristics associated with the vehicle, wherein the one or more characteristics include a state of charge of a battery, a step of a manufacturing process, a key fob, a phone as a key feature, Bluetooth® low energy-based wireless communication, cellular-based wireless communication, wireless fidelity-based wireless communication, or a combination thereof.

7. The method of claim 1, wherein the one or more actions include marshaling of the vehicle to a repair bay, a parking location, or a future location.

8. A system comprising:
a vehicle system configured to:
determine a current status associated with a vehicle,
output, via a lighting element of the vehicle, a first indication corresponding to the current status associated with the vehicle,
receive one or more marshaling commands based on the first indication, and
initiate one or more actions in response to the receipt of the one or more marshaling commands; and
an infrastructure system configured to:
observe the first indication, and
transmit the one or more marshaling commands based on the observation of the first indication.

9. The system of claim 8, wherein the vehicle is a partially built vehicle configured to be marshaled through a manufacturing environment, and wherein the lighting element is permanently integrated within a body of the vehicle or temporarily affixed to the body of the vehicle.

10. The system of claim 9, wherein the manufacturing environment includes one or more workstations equipped with an electronic device, and wherein the electronic device is configured to output a second indication, and further wherein the second indication is a visual cue that corresponds to a step of a manufacturing process, a destination of the vehicle, a corresponding location associated with the vehicle, a delay in the manufacturing process associated with the vehicle, a delay in a marshaling process associated with the vehicle, a duration of the vehicle being stopped, or a combination thereof.

11. The system of claim 10, wherein the first indication and the second indication comprise a light color output, a sequence of light output, or a combination thereof.

12. The system of claim 8, wherein the first indication is outputted by different parts of the lighting element corresponding to different vehicle systems, and wherein the first indication is a visual cue that corresponds to a location associated with a construct of the vehicle that needs repair, a location associated with the construct of the vehicle that needs inspection, a fault associated with the vehicle, a trajectory associated with a current movement of the vehicle, a predicted future location associated with the vehicle, one or more vehicle options, or a combination thereof.

13. The system of claim 8, wherein a frequency and a duration of the output of the first indication varies based on global positioning system coordinates of the vehicle and one or more characteristics associated with the vehicle, wherein the one or more characteristics include a state of charge of a battery, a step of a manufacturing process, a key fob, a phone as a key feature, Bluetooth® low energy-based wireless communication, cellular-based wireless communication, wireless fidelity-based wireless communication, or a combination thereof.

14. The system of claim 8, wherein the one or more actions include marshaling of the vehicle to a repair bay, a parking location, or a future location.

15. One or more non-transitory computer-readable media storing processor-executable instructions that, when executed by at least one processor, cause the at least one processor to:
determine a current status associated with a vehicle;
output, via a lighting element of the vehicle, a first indication corresponding to the current status associated with the vehicle;
receive one or more marshaling commands based on the first indication; and
initiate one or more actions in response to the receipt of the one or more marshaling commands, wherein the one or more actions include marshaling of the vehicle to a repair bay, a parking location, or a future location.

16. The one or more non-transitory computer-readable media of claim 15, wherein the vehicle is a partially built vehicle configured to be marshaled through a manufacturing environment, and wherein the lighting element is permanently integrated within a body of the vehicle or temporarily affixed to the body of the vehicle.

17. The one or more non-transitory computer-readable media of claim 16, wherein the manufacturing environment includes one or more workstations equipped with an electronic device, and wherein the electronic device is configured to output a second indication, and further wherein the second indication is a visual cue that corresponds to a step of a manufacturing process, a destination of the vehicle, a corresponding location associated with the vehicle, a delay in the manufacturing process associated with the vehicle, a delay in a marshaling process associated with the vehicle, a duration of the vehicle being stopped, or a combination thereof.

18. The one or more non-transitory computer-readable media of claim 17, wherein the first indication and the second indication comprise a light color output, a sequence of light output, or a combination thereof.

19. The one or more non-transitory computer-readable media of claim 15, wherein the first indication is outputted by different parts of the lighting element corresponding to different vehicle systems, and wherein the first indication is a visual cue that corresponds to a location associated with a construct of the vehicle that needs repair, a location associated with the construct of the vehicle that needs inspection, a fault associated with the vehicle, a trajectory associated with a current movement of the vehicle, a predicted future location associated with the vehicle, one or more vehicle options, or a combination thereof.

20. The one or more non-transitory computer-readable media of claim 15, wherein a frequency and a duration of the output of the first indication varies based on global positioning system coordinates of the vehicle and one or more characteristics associated with the vehicle, wherein the one or more characteristics include a state of charge of a battery, a step of a manufacturing process, a key fob, a phone as a key feature, Bluetooth® low energy-based wireless communication, cellular-based wireless communication, wireless fidelity-based wireless communication, or a combination thereof.
